(19) United States
(12) Patent Application Publication
(10) Pub. No.: US 2011/0302759 A1
(43) Pub. Date: Dec. 15, 2011

(54) FLOATING CAPTIVE SCREW INSTALLATION METHOD

(76) Inventor: Ming-Chung CHIU, Keelung CIty (TW)

(21) Appl. No.: 12/814,850

(22) Filed: Jun. 14, 2010

(51) Int. Cl. B23P 11/00

(52) U.S. Cl. 29/428

(57) ABSTRACT

A floating captive screw installation method includes the step of inserting a lock screw through a spring member and then inserting the lock screw with the spring member into a stepped barrel, the step of inserting the stepped barrel with the spring member and the lock screw into a rotary cap to keep the head of the lock screw outside the rotary cap, the step of forcing a toothed engagement portion of the head of the lock screw into engagement with a retaining groove in the top open side of the rotary cap tightly, and the step of letting a front coupling flange of the rotary cap be stopped against the bottom side of a top coupling flange of the stepped barrel. This installation method eliminates a secondary processing process, saving much installation labor and time.

### BACKGROUND OF THE INVENTION

1. Field of the Invention

The present invention relates to the application of a floating captive screw for joining two metal plate members and more particularly, to a floating captive screw installation method, which facilitates installation, avoids a secondary processing process during installation, and saves much installation time and labor.

2. Description of the Related Art

When fastening plate members together, a positioning screw formed of a knob, a ring and a screw nail is usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing.

To facilitate detachable installation, floating captive screws are developed. Conventional floating captive screws are commonly formed of a cap member, a screw, a spring member and a mounting barrel, and adapted for locking into plate on a first plate member, enabling the easy installation and removal of attached pieces without release of the screw.

FIGS. 7 and 8 show a floating captive screw according to the prior art. According to this design, a screw A1 is fastened to a mounting hole A0 of a cap member A, and then a spring member A2 is sleeved onto the screw A1 in the cap member A, and then a mounting barrel B is sleeved onto the spring member A2. To preventing falling of the mounting barrel B from the cap member A due to the effect of the spring force of the spring member A2, a working tube C is used to bend the relatively thinner bottom end of the cap member A from an axially extending status into an obliquely inwardly extending oblique stop flange A3 for stopping against the top flange B1 of the mounting barrel B to prohibit escape of the mounting barrel B from the cap member A. During application, the bottom bonding portion B2 of the mounting barrel B is bonded to a plate member with a solder paste. After bonding, the screw A1 can be moved with the cap member A relative to the mounting barrel B within a distance corresponding to the length of the mounting barrel B between its top flange B1 and bottom bonding portion B2. Thus, the floating captive screw is locked into plate on the plate member, enabling the easy installation and removal of attached pieces without release of the screw.

However, according to the aforesaid prior art design, when the spring member A2 and the mounting barrel B are sleeved onto the screw A1 after fixation of the screw A1 and the cap member A, a secondary processing process is necessary to process the relatively thinner bottom end of the cap member A into an oblique stop flange A3 for stopping against the top flange B1 of the mounting barrel B to prohibit escape of the mounting barrel B from the cap member A. This secondary processing process requires much labor and time, and complicates the installation procedure. During processing, precision control is critical to avoid excessive deformation of the relatively thinner bottom end of the cap member A. Further, during delivery of the cap member A by a vibrating conveyor, the oblique stop flange A3 of the cap member A may be forced to deform.

Further, an inner diameter C0 of the working tube C is greater than the outer diameter of the bottom bonding portion B2 of the mounting barrel B so that the working tube C can be sleeved onto the mounting barrel B to force the pressure face C1 thereof against the relatively thinner bottom end of the cap member A. When forcing the relatively thinner bottom end of the cap member A to form an oblique stop flange A3, the elevational difference between a periphery B3 and the bottom bonding portion B2 of the mounting barrel B does not allow the pressure face C1 to force the oblique stop flange A3 into close contact with the bottom wall of the top flange B1 of the mounting barrel B. Thus, the cap member A and the screw A1 may oscillate relative to the mounting barrel B, or may be biased relative to the mounting barrel B during installation, causing damage. Further, the cap member A is made of aluminum, and then surface treated through an anodization process. However, when forcing the relatively thinner bottom end of the cap member A to form the desired oblique stop flange A3, the surface of the cap member A may be wrinkled or damaged, lowering the structural strength.

Therefore, it is desirable to provide a floating captive screw installation method that eliminates the aforesaid problems.

### SUMMARY OF THE INVENTION

The present invention has been accomplished under the circumstances in view. It is therefore an object of the present invention to provide a floating captive screw installation method, which facilitates floating captive screw installation, saving much installation labor and time.

To achieve this and other objects of the present invention, a floating captive screw installation method includes the step of inserting a lock screw through a spring member and then inserting the lock screw with the spring member into a stepped barrel, the step of inserting the stepped barrel with the spring member and the lock screw into a rotary cap to keep the head of the lock screw outside the rotary cap, the step of forcing a toothed engagement portion of the head of the lock screw into engagement with a retaining groove in the top open side of the rotary cap tightly, and the step of letting a front coupling flange of the rotary cap be stopped against the bottom side of a top coupling flange of the stepped barrel. The rotary cap is processed to form the desired front coupling flange, and then assembled with the lock screw. Thus, no further secondary processing process is necessary during installation of the floating captive screw, saving much time and labor, improving product quality, and effectively lowering the manufacturing cost.

Further, rotary cap is processed to form the desired front coupling flange by a machine tool, such as lathe or milling machine. Thus, the peripheral wall of the rotary cap can be made having a uniform wall thickness, assuring high structural strength and avoiding damage or improper deformation during formation of the front coupling flange.

Further, when moving the lock screw with the rotary cap axially relative to the stepped barrel, the top coupling flange of the stepped barrel is kept in contact with the inside wall of the rotary cap to stabilize axial displacement of the lock screw, avoiding vibration or potential damage.

### BRIEF DESCRIPTION OF THE DRAWINGS

FIG. 1 illustrates a floating captive screw installation flow in accordance with the present invention.

FIG. 2 is an exploded view of a floating captive screw in accordance with the present invention.

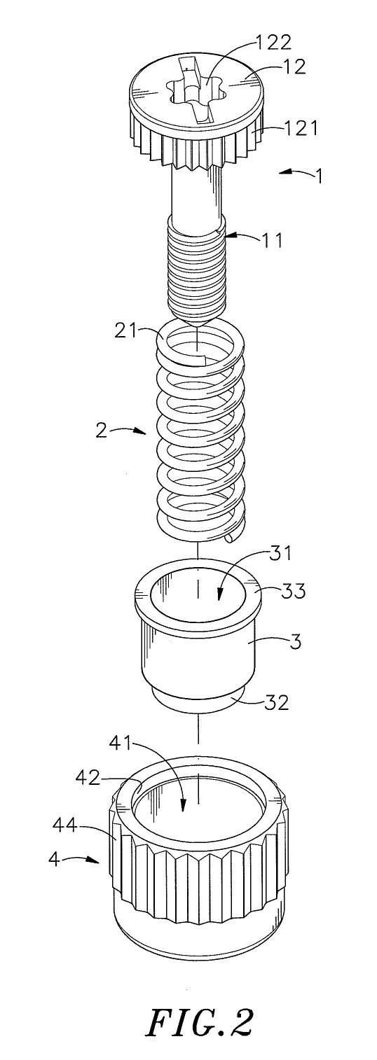

FIG. 3 is a sectional assembly view of the floating captive screw in accordance with the present invention before insertion of the lock screw with the spring member and the stepped barrel in the rotary cap.

FIG. 4 is an oblique elevation of the floating captive screw in accordance with the present invention.

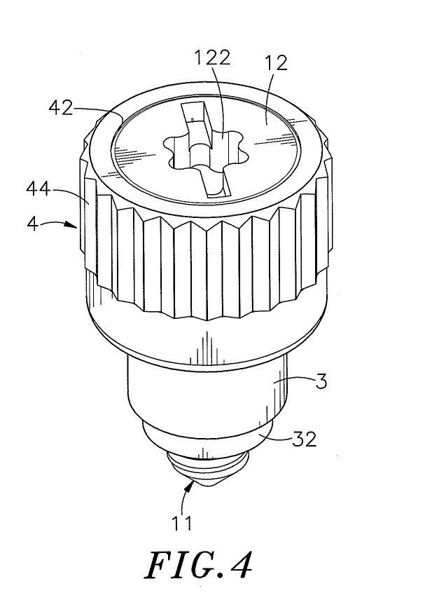

FIG. 5 is a schematic sectional view of the present invention, showing the floating captive screw installed in a first plate member before fixation to a second plate member.

FIG. 6 corresponds to FIG. 5, showing the lock screw threaded into the mounting screw hole on the second plate member.

FIG. 7 is a schematic sectional view, showing a secondary processing status of a floating captive screw according to the prior art.

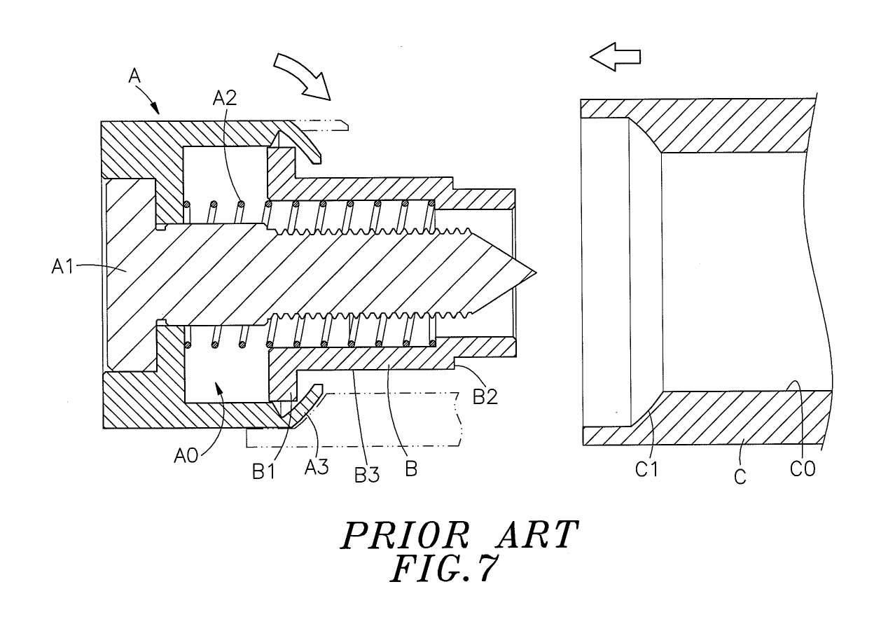

FIG. 8 is an oblique elevation of the processed prior art floating captive screw.

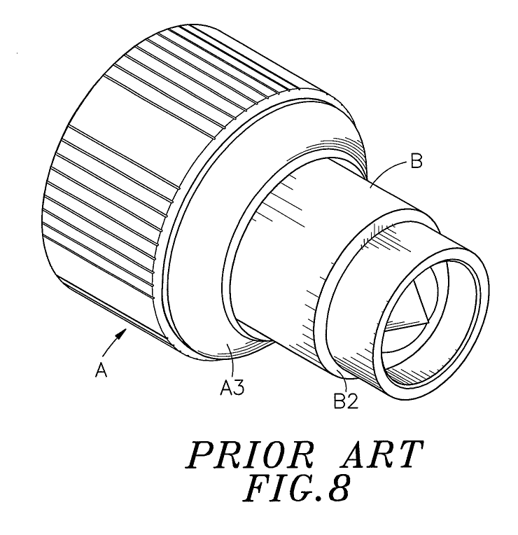

### DETAILED DESCRIPTION OF THE PREFERRED EMBODIMENT

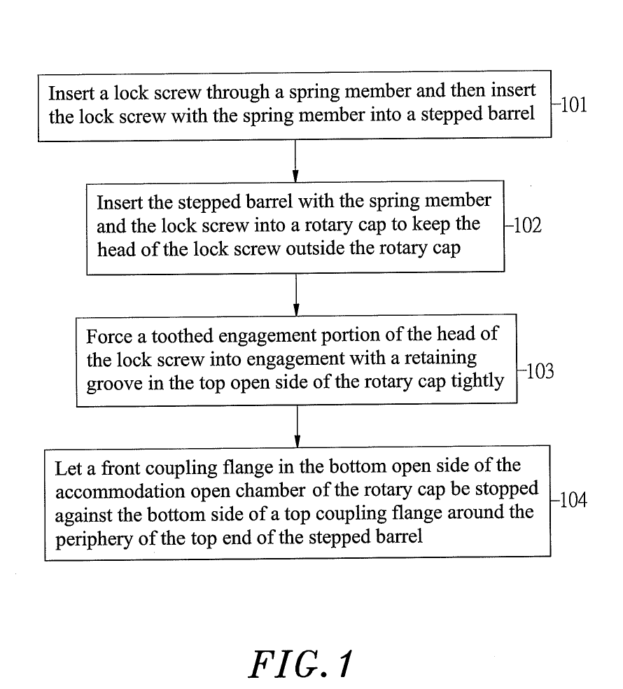

Referring to FIGS. 1˜4, a floating captive screw installation method in accordance with the present invention includes the following steps:
(101) Insert a threaded shank 11 of a lock screw 1 through a spring member 2, and then insert the threaded shank 11 of the lock screw 1 with the spring member 2 into a center opening 31 of a stepped barrel 3;
(102) Insert the stepped barrel 3 with the spring member 2 and the threaded shank 11 of the lock screw 1 into an accommodation open chamber 41 of a rotary cap 4, keeping a head 12 of the lock screw 1 outside the rotary cap 4;
(103) Force a toothed engagement portion 121 of the head 12 of the lock screw 1 into engagement with a retaining groove 42 in the top open side of the accommodation open chamber 41 of the rotary cap 4 tightly; and
(104) Let a front coupling flange 43 in the bottom open side of the accommodation open chamber 41 of the rotary cap 4 be stopped against the bottom side of a top coupling flange 33 around the periphery of the top end of the stepped barrel 3.

As stated above, a floating captive screw in accordance with the present invention comprises a lock screw 1, a spring member 2, a stepped barrel 3 and a rotary cap 4. During installation, an automatic machine is operated to insert the threaded shank 11 of the lock screw 1 through the spring member 2 and the stepped barrel 3, for enabling the spring member 2 to be accommodated in the stepped barrel 3 and stopped between the head 12 of the lock screw 1 and an annular inside step 311 of the stepped barrel 3. Alternatively, the automatic machine can be operated to sleeve the spring member 2 onto the threaded shank 11 of the lock screw 1 and then to insert the threaded shank 11 of the lock screw 1 into the center opening 31 of the stepped barrel 3, for enabling the spring member 2 to be accommodated in the stepped barrel 3 and stopped between the head 12 of the lock screw 1 and the annular inside step 311 of the stepped barrel 3. Thereafter, the threaded shank 11 of the lock screw 1 is inserted with the spring member 2 and the stepped barrel 3 into the accommodation open chamber 41 of the rotary cap 4, keeping the head 12 of the lock screw 1 outside the rotary cap 4. Thereafter, the toothed engagement portion 121 of the head 12 of the lock screw 1 can be forced into engagement with the retaining groove 42 in the top open side of the accommodation open chamber 41 of the rotary cap 4 by means of the application of tool means. Thus, the rotary cap 4 is tightly capped onto the head 12 of the lock screw 1, and the top wall of the head 12 of the lock screw 1 is exposed to the outside of the rotary cap 4.

When the rotary cap 4 is capped onto the head 12 of the lock screw 1, the front coupling flange 43 in the bottom open side of the accommodation open chamber 41 of the rotary cap 4 is stopped against the bottom side of the top coupling flange 33 around the periphery of the top end of the stepped barrel 3. At this time, the two opposite end portions 21 of the spring member 2 are respectively stopped against the bottom wall of the head 12 of the lock screw 1 and an annular inside step 311 in the center opening 31 of the stepped barrel 3. Thus, the lock screw 1 can be moved with the rotary cap 4 axially relative to the stepped barrel 3 to compress the spring member 2, which returns the lock screw 1 automatically when the external pressure is disappeared.

When moving the lock screw 1 with the rotary cap 4 axially relative to the stepped barrel 3, the top coupling flange 33 of the stepped barrel 3 is kept in contact with the inside wall of the rotary cap 4 to stabilize axial displacement of the lock screw 1, avoiding vibration or potential damage. The rotary cap 4 is processed to form the desired front coupling flange 43 by a machine tool (lathe or milling machine), and then assembled with the lock screw 1. Thus, no further secondary processing process is necessary, saving much time and labor, improving product quality, and effectively lowering the manufacturing cost.

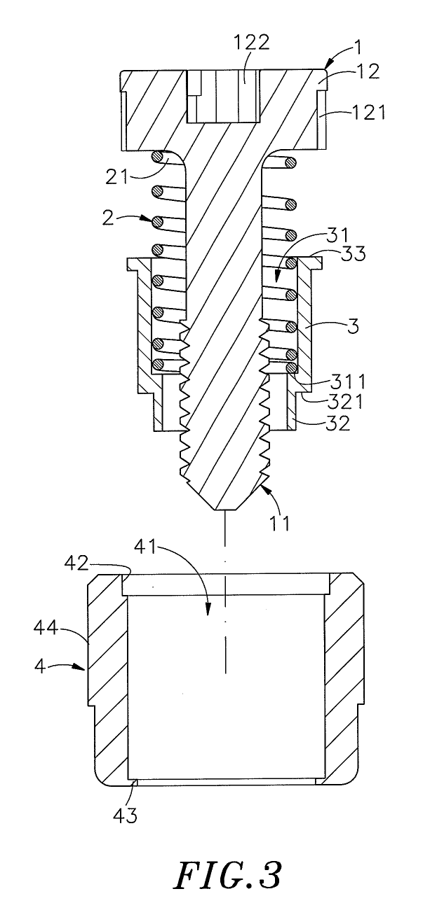

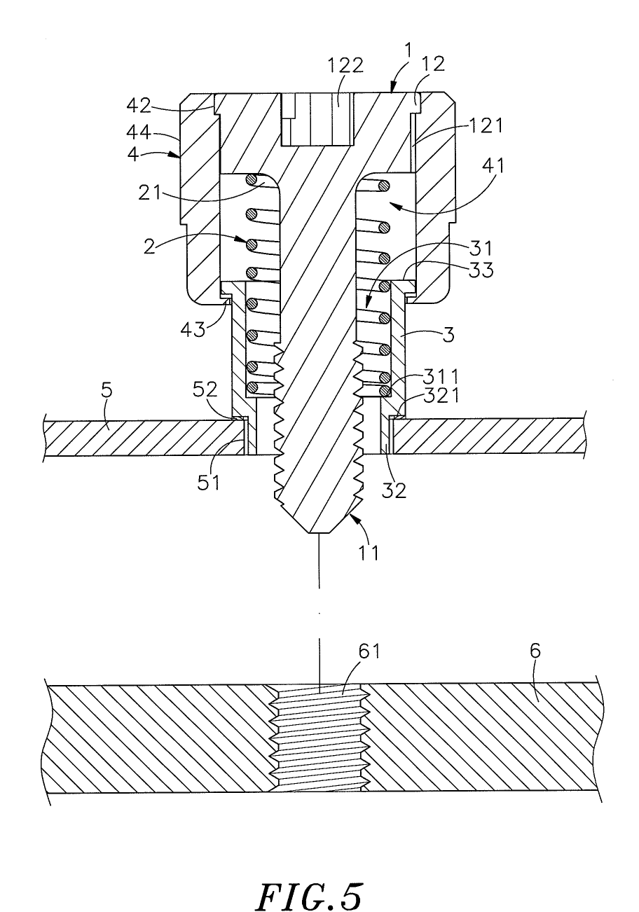

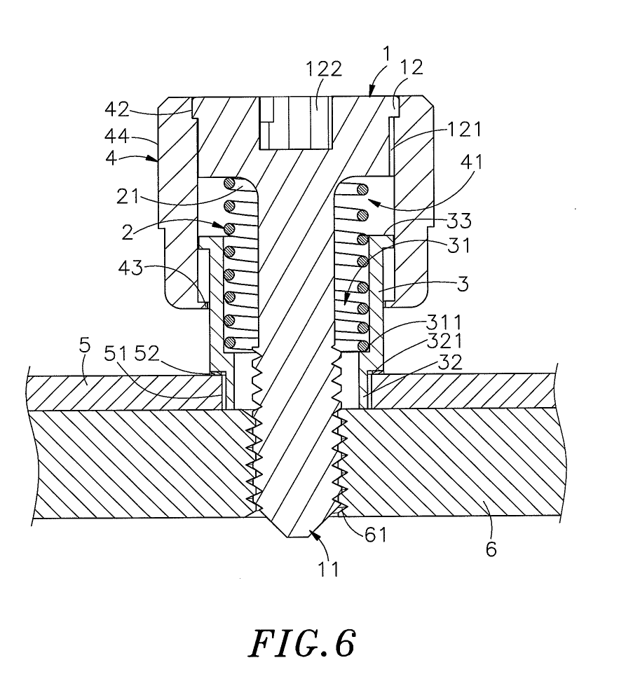

Referring to FIGS. 3, 5 and 6, a floating captive screw in accordance with the present invention comprises a lock screw 1, a spring member 2, a stepped barrel 3 and a rotary cap 4.

The lock screw 1 has a head 12, a threaded shank 11 perpendicularly extended from the center of the bottom wall of the head 12, a toothed engagement portion 121 located on the periphery of the head 12, and a tool groove 122 located on the top wall of the head 12. Further, the tool groove 122 can be a Phillipes groove, keystone groove, asterisk groove or hex groove.

The spring member 2 is set between the lock screw 1 and the stepped barrel 3, having two opposing end portions 21.

The stepped barrel 3 is a stepped hollow cylinder having a center opening 31 cut through top and bottom ends thereof for accommodating the spring member 2 and for the passing of the threaded shank 11 of the lock screw 1, an annular inside step 311 disposed in the center opening 31 for stopping against one end portion 21 of the spring member 2, a contracted bottom mounting portion 32 axially disposed at the bottom end, a bonding face 321 transversely disposed at the top side of the contracted bottom mounting portion 32 and a top coupling flange 33 extending around the periphery of the top end.

The rotary cap 4 is a hollow cylindrical member, having an accommodation open chamber 41 defined therein for accommodating the lock screw 1, the spring member 2 and the stepped barrel 3, a retaining groove 42 extending around the top open side of the accommodation open chamber 41 for engagement with the toothed engagement portion 121 of the head 12 of the lock screw 1, a front coupling flange 43 inwardly protruded from the front end thereof around the front open side of the accommodation open chamber 41 for stopping against the top coupling flange 33 of the stepped barrel 3, and an embossed grip 44 formed integral with the periphery.

Further, the lock screw 1 is made of metal. The rotary cap 4 can be made of metal. Alternatively, the rotary cap 4 can be directly molded from a plastic material on the head 12 of the lock screw 1 by over-molding technology. Further, the toothed engagement portion 121 of the head 12 of the lock screw 1 can be formed of barbs, teeth or cones for positive engagement with the retaining groove 42 of the rotary cap 4. After engagement between the toothed engagement portion 121 of the head 12 of the lock screw 1 and the retaining groove 42 of the rotary cap 4, a user can operate the embossed grip 44 of the rotary cap 4 to rotate the lock screw 1 into the workpiece. Further, the contracted bottom mounting portion 32 of the stepped barrel 3 is press-fitted into a mounting through hole 51 of a first plate member 5. During application, as an example of the present invention, an automatic installation machine, for example, mechanical arm is operated to pick up the stepped barrel 3 and then to insert the contracted bottom mounting portion 32 of the stepped barrel 3 into a mounting through hole 51 of a first plate member 5, for enabling the bonding face 321 of the stepped barrel 3 to be stopped at a solder paste 52 on the top wall of the first plate member 5 around the mounting through hole 51, and then a reflow bonding process is performed to bond the contracted bottom mounting portion 32 of the stepped barrel 3 to the first plate member 5. Further, the contracted bottom mounting portion 32 of the stepped barrel 3 may be tin-plated for easy bonding to the first plate member 5.

When fastening the first plate member 5 to a second plate member 6, attach the first plate member 5 to the second plate member 6 to keep the mounting through hole 51 of the first plate member 5 in axial alignment with a corresponding mounting screw hole 61 on the second plate member 6, and then press down the rotary cap 4 and the lock screw 1 by hand, and then rotate the rotary cap 4 to thread the threaded shank 11 of the lock screw 1 into the mounting screw hole 61 of the second plate member 6, thereby locking the first metal plate member 5 and the second plate member 6 together. Further, a hand tool, for example, screwdriver may be used and attached to the tool groove 122 for driving the lock screw 1 into the mounting screw hole 61 of the second plate member 6 rapidly with less effort.

It is to be understood that the above description simply for purposes of illustration only, but not intended as a limitation. For example, the coupling arrangement between the front coupling flange 43 of the rotary cap 4 and the top coupling flange 33 of the stepped barrel 3 may be substituted by: attaching a stop ring (not shown) to the lock screw 1 for stopping against a part in the stepped barrel 3 to constrain axial movement relative to the stepped barrel 3 within a predetermined range. Further, after insertion of the lock screw 1 with the spring member 2 and the stepped barrel 3 into the rotary cap 4, the toothed engagement portion 121 of the head 12 of the lock screw 1 is forced into engagement with the retaining groove 42 of the rotary cap 4 tightly by a machine tool. Because the front coupling flange 43 of the rotary cap 4 is made prior to insertion of the lock screw 1 with the spring member 2 and the stepped barrel 3 into the rotary cap 4, no further secondary processing process is necessary, saving much time and labor.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A floating captive screw installation method, comprising the steps of:
(a) inserting a threaded shank of a lock screw through a spring member and then inserting said threaded shank of said lock screw with said spring member into a center opening of a stepped barrel;
(b) inserting said stepped barrel with said spring member and said threaded shank of said lock screw into an accommodation open chamber of a rotary cap to keep a head of said lock screw outside said rotary cap;
(c) forcing a toothed engagement portion of said head of said lock screw into engagement with a retaining groove in a top open side of said accommodation open chamber of said rotary cap tightly; and
(d) letting a front coupling flange in a bottom open side of said accommodation open chamber of said rotary cap be stopped against the bottom side of a top coupling flange around the periphery of the top end of said stepped barrel.

2. The floating captive screw installation method as claimed in claim 1, wherein said toothed engagement portion of said head of said lock screw is formed of barbs, teeth or cones, and forced into engagement with said retaining groove in said top open side of said accommodation open chamber of said rotary cap tightly by a machine tool during step (c).

3. The floating captive screw installation method as claimed in claim 1, wherein said rotary cap is processed to form said front coupling flange by a machine tool selected from a group of lathe and milling machine during step (d).

4. The floating captive screw installation method as claimed in claim 1, wherein said spring member has two opposite end portions that are respectively stopped against said head of said lock screw and a part inside said stepped barrel during step (d).

5. The floating captive screw installation method as claimed in claim 1, wherein said stepped barrel has a contracted bottom mounting portion bonded to a mounting through hole on a first plate member for allowing said lock screw to be moved axially toward said first plate member and rotated into a mounting screw hole on a second plate member to lock said second plate member to said first plate member after step (d).
